(19) United States
(12) Patent Application Publication
(10) Pub. No.: US 2014/0244726 A1
(43) Pub. Date: Aug. 28, 2014

(54) Assignment of Point-to-Point Over Ethernet (PPPoE) Session IDs

(71) Applicant: Hangzhou H3C Technologies Co., Ltd., Hangzhou (CN)

(72) Inventor: Yuanxiang Qiu, Beijing (CN)

(73) Assignee: Hangzhou H3C Technologies Co., Ltd., Hangzhou (CN)

(21) Appl. No.: 14/133,604

(22) Filed: Dec. 18, 2013

(30) Foreign Application Priority Data
Feb. 25, 2013 (CN) 201310059601.5

(51) Int. Cl. H04L 29/06

(52) U.S. Cl. CPC H04L 67/42
USPC 709/203

(57) ABSTRACT

The present disclosure describes assignment of Point-to-Point Protocol over Ethernet (PPPoE) session identifiers (IDs). A PPPoE server receives a session request from a first PPPoE client to establish a new session with the PPPoE server. Based on the session request, the PPPoE server selects a session ID for the new session with the first PPPoE client and broadcasts a probe request carrying the session ID and a Media Access Control (MAC) address of the PPPoE server. When a probe response carrying the session ID is received from a second PPPoE client within a predetermined time period, the probe response indicating that a prior session previously established with the second PPPoE client is assigned with same session ID, the PPPoE server terminates the prior session with the second PPPoE client before assigning the session ID to the new session with the first PPPoE client.

### CROSS-REFERENCE TO RELATED APPLICATIONS

This application claims priority to CN Patent Application No. 201310059601.5, filed on Feb. 25, 2013, entitled “A Method and Equipment for PPPoE Session ID Distribution,” which is incorporated herein by reference.

### BACKGROUND

Point-to-Point Protocol over Ethernet (PPPoE) is a network protocol for encapsulating Point-to-Point Protocol (PPP) frames within Ethernet frames to facilitate point-to-point connections over Ethernet. PPPoE also provides access control and billing functionalities and is widely used in various networking environments, such as cell networking etc. Using PPPoE, hosts on an Ethernet network access Internet services via a remote access device.

PPPoE adopts a Client/Server architecture. A PPPoE server uniquely identifies a session according to a Media Access Control (MAC) address and a Session identifier (ID) of a PPPoE client. If multiple PPPoE clients sharing the same MAC address each request for a connection, the PPPoE server assigns a different Session ID to each of them.

PPPoE generally has two stages: discovery and session. The discovery stage is a negotiation stage where the PPPoE server assigns a Session ID to a PPPoE client and establishes a PPPoE session with the client. Either the PPPoE client or PPPoE server may terminate the session. During the PPP session stage, PPP data is sent between the PPPoE server and PPPoE client.

### BRIEF DESCRIPTION OF DRAWINGS

By way of non-limiting examples, the present disclosure will be described with reference to the following drawings, in which:

FIG. 1 is a flow diagram of an example process for assigning PPPoE session IDs;

FIG. 2 is a schematic diagram of an example network in which PPPoE session IDs are assigned;

FIG. 3 is a flow diagram of an example of the process in FIG. 1 when implemented in the example network in FIG. 2;

FIG. 4 is a schematic diagram of a first example structure of a network device capable of acting as a PPPoE server;

FIG. 5 is a schematic diagram of a second example of a network device capable of acting as a PPPoE server;

FIG. 6 is a schematic diagram of a first example structure of a network device capable of acting as a PPPoE client; and

FIG. 7 is a schematic diagram of a second example of a network device capable of acting as a PPPoE client.

### DETAILED DESCRIPTION

In a PPPoE network, there are situations where a conflict may occur in the assignment of PPPoE session IDs. One reason is because an assigned session ID may only be unique at the PPPoE server for a period of time. If the PPPoE server restarts due to a failure or abnormal process, information of assigned session IDs and corresponding sessions will be lost. For example, after a restart, the PPPoE server might assign a session ID to a first PPPoE client, without knowing that the same session ID has been previously assigned to another session with a second PPPoE client prior to the restart.

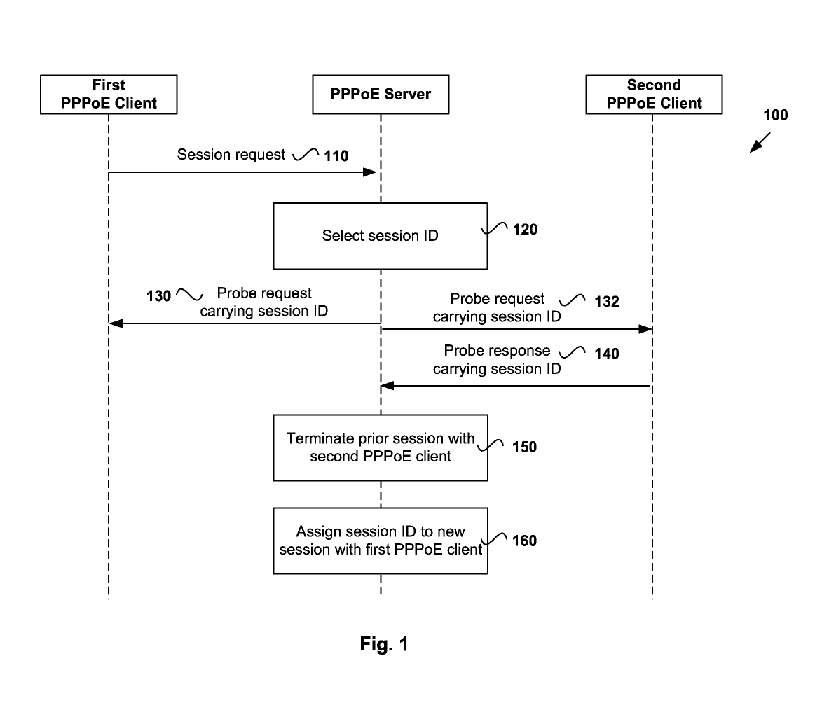

According to examples of the present disclosure and referring to FIG. 1, a PPPoE server assigns a PPPoE session ID as follows:
At 110, the PPPoE server receives a session request from a first PPPoE client to establish a new session with the PPPoE server.
At 120, the PPPoE server selects a session ID for the new session with the first PPPoE client based on the session request.
At 130 and 132, the PPPoE server broadcasts a probe request carrying the session ID and a Media Access Control (MAC) address of the PPPoE server.
At 140 and 150, when a probe response carrying the session ID is received from a second PPPoE client within a predetermined time period, the PPPoE server terminates a prior session with the second PPPoE client. The probe response indicates that the prior session is previously established with the second PPPoE client and assigned with the same session ID.
At 160, the PPPoE server assigns the session ID to the new session with the first PPPoE client.

According to examples of the present disclosure, prior to assigning a session ID to a new session, the PPPoE server attempts to detect any potential conflict in the assignment of the session ID by broadcasting the probe request carrying the session ID. If the second PPPoE client has previously established a session with the PPPoE server and that prior session is assigned with the same session ID, the second PPPoE client responds with a probe response carrying the session ID to initiate a termination of the session.

Using the probe request and probe response, a situation whether the same session ID is inadvertently assigned to two different PPPoE clients is prevented or at least reduced in likelihood. Otherwise, if both the first and second PPPoE clients have the same MAC address, the communication with the PPPoE server becomes point-to-multipoint (one session ID, two clients) instead of the intended point-to-point. In this case, data of the second PPPoE client might be mistaken as that of the first PPPoE client, resulting in data processing errors. According to examples of the present disclosure, such data processing errors and associated inefficient use of network and processing resources may be prevented or at least reduced in likelihood.

Further, examples of the present disclosure also accelerate the session failure detection and re-establishment of a new session by the second PPPoE client. The probe request allows the second PPPoE client to sense that the PPPoE server has failed. Otherwise, the second PPPoE usually waits for the expiration of a keep-alive timer set by an upper layer protocol of the PPP at the second PPPoE client Terminating the session between the PPPoE server and second PPPoE client releases the session ID for the first PPPoE client, therefore improving the reliability of the new session and resource usage rate. Wastage of processing resources caused by the second PPPoE client sending data prior to sensing the failure can be reduced.

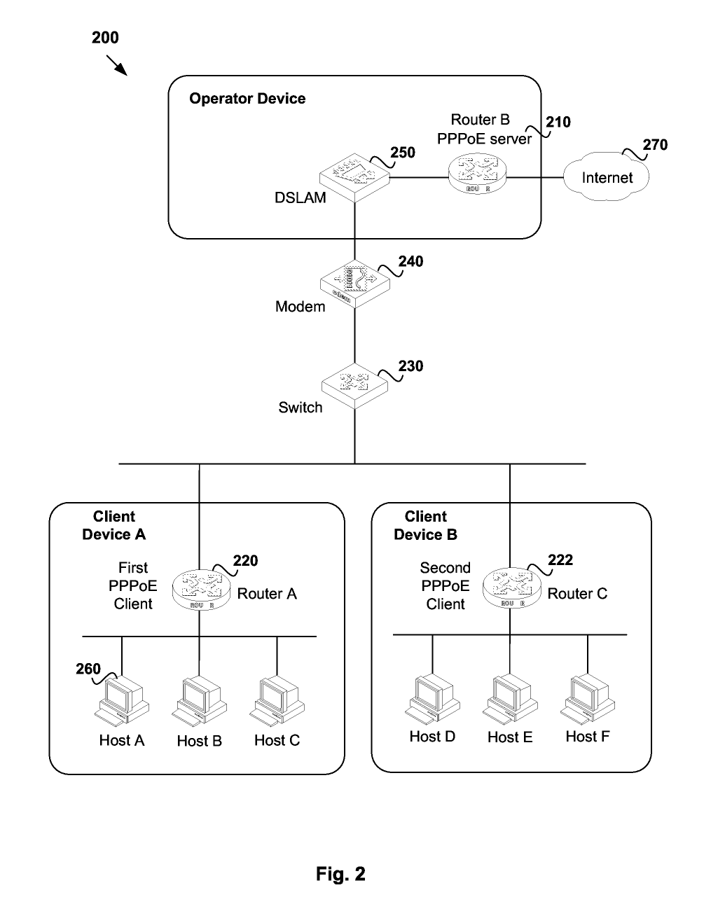

Examples of the present disclosure will be described with reference to accompanying drawings. FIG. 2 shows an example network 200 in which PPPoE session IDs may be assigned according to the processes in FIG. 1. The network 200 includes the following:
PPPoE server 210 (e.g. Router B) in an operator's network for performing processes relating to PPPoE sessions with multiple PPPoE clients 220, 222 in the network 200.
PPPoE clients 220, 222 (e.g. Routers A and C) for establishing sessions with the PPPoE server 210 via intermediate devices such as a switch device 230, modem 240 and digital subscriber line access multiplexer (DSLAM) 250 etc. Router A (“first PPPoE client” 220) and Router C (“second PPPoE client” 222) are installed with PPPoE client software to communicate with the PPPoE server 210.
Hosts 260 (e.g. hosts A to F) connected to the PPPoE clients 220, 222 access a wide area communications network 270 (e.g. the Internet) through a PPPoE session between the PPPoE clients 220, 222 and the PPPoE server 210. The hosts 260 may be any suitable computing device, such as a mobile communications device, personal computer or a network device such as a server etc.

It will be appreciated that although one PPPoE server 210 and two PPPoE clients 220, 222 are shown for simplicity, the network 200 may include many more PPPoE servers and clients. On a more abstract level, the PPPoE server 210 and DSLAM represent a device in an operator's network. Similarly, the first PPPoE client 220 and hosts A to C represent “client device A” and the second PPPoE client 222 and hosts D to F represent “client device B”.

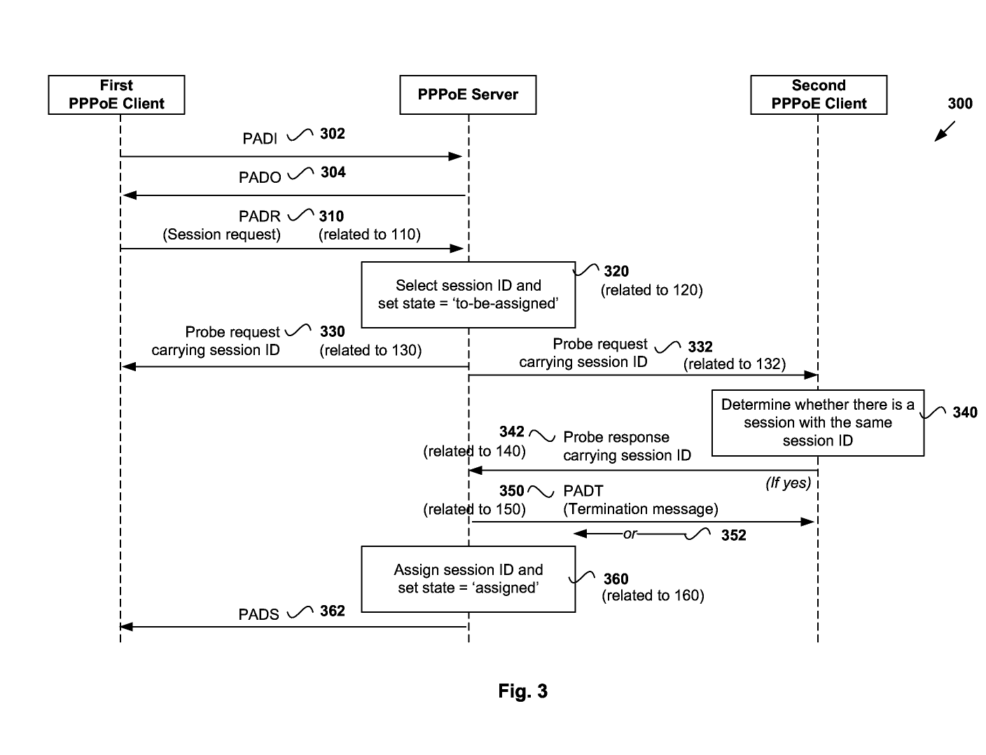

Referring now to FIG. 3, the establishment of a session and assignment of session IDs will now be explained in more detail. The process of establishing a PPPoE session includes a discovery stage and a session stage (also known as a PPP session state). Upon the completion of the discovery stage, both the PPPoE server 210 and PPPoE client 220 (also known as peers) learn the session ID and each other's MAC address and the session stage commences.

In the example in FIG. 2 and FIG. 3, the first PPPoE client 220 (e.g. Router A) wishes to establish a session with the PPPoE server 210 (e.g. Router B), which proceeds to assign a session ID for the session. However, the second PPPoE client 222 (e.g. Router C) has previously established a session having the same session ID, for example, before the PPPoE server 210 restarts and loses all relevant information. The example in FIG. 1 is applied to prevent or reduce the likelihood of an assignment conflict.

Service Request

To establish a session during the discovery stage, the first PPPoE client 220 searches for all available PPPoE servers 210. In more detail:
At 302 in FIG. 3, the first PPPoE client 220 broadcasts a PPPoE Active Discovery Initiation (PADI) message to request services from the PPPoE server 210. The PADI message includes at least a tag with TAG_TYPE Service-Name (with tag type field value 0x0101), a destination address of Ethernet broadcast address 0xffffffffffff, a CODE field value of 0x09, and a SESSION_ID field value of 0x0000.
At 304 in FIG. 3, upon receiving the PADI message, the PPPoE server 210 replies with a PPPoE Active Discovery Offer (PADO) message to indicate that it is able to provide services. The PADO message carries a tag with TAG_TYPE Name indicating the PPPoE server's name (with tag type field value 0x0102) as well as a tag with TAG_TYPE Service-Name indicating the service type. The destination address of the PADO message is the MAC address of the first PPPoE client 220, its CODE field value is 0x07, and its SESSION_ID field value remains as 0x0000.

If the first PPPoE client 220 does not receive any PADO message from the PPPoE server 210 within a predetermined time period, it may re-broadcast the PADI message to request for services again.

Although one PPPoE server 210 is shown in FIG. 2 for simplicity, it should be noted that there might be multiple PPPoE servers 210 that can provide services to the first PPPoE client 220. In this case, since the PADI message is broadcasted, the first PPPoE client 220 may receive multiple PADO messages in reply. One of the PPPoE servers 210 is then selected for the subsequent processes, such as based on the services offered etc.

Once the PPPoE server 210 is selected, the first PPPoE 220 confirms with the selected PPPoE server 210 to accept the offer of a PPPoE session.
At 310 in FIG. 3 (related to 110 in FIG. 1), the first PPPoE client 220 sends a session request in the form of a PPPoE Active Discovery Request (PARR) to the PPPoE server 210. The PADR message carries a tag of TAG_TYPE Service-Name, a destination address of the selected PPPoE server's 210 MAC address, a CODE field of 0x19, and a SESSION_ID field value of 0x0000.
At 320 in FIG. 3 (related to 120 in FIG. 1), after receiving the PADR message from the first PPPoE client 220, the PPPoE server 210 selects a session ID for a new session with the first PPPoE client 220.

To manage the session IDs, the PPPoE server 210 may set the state of a session ID to ‘idle’, ‘to-be-assigned’ or ‘assigned’. At 320, the PPPoE server 210 selects a session ID in an ‘idle’ state and reserves it for the first PPPoE client 220. After selecting a session ID, the PPPoE server 210 updates the state from ‘idle’ to ‘to-be-assigned’. This prevents the PPPoE server 210 assigning session IDs in a ‘to-be-assigned’ state to a different PPPoE client if it receives another PADR message.

Probe Request and Probe Response

Prior to assigning the session ID to the first PPPoE client 220, a detection or probing process is performed to detect any potential conflict in the assignment of the session ID selected at 320 in FIGS. 3.
At 330 and 332 in FIG. 3 (related to 130 and 132 in FIG. 1), the PPPoE server 210 broadcasts a probe request that carries the session ID and the MAC address of the PPPoE server 210. The probe request is for detecting whether the session ID has been used by a second PPPoE client 222.
At 340 in FIG. 3 (related to 140 in FIG. 1), the second PPPoE client 222 receives the probe request and determines whether there is an established session which matches with the session ID in the probe request. For example, the second PPPoE client 222 searches its local session information to determine whether there is a session with the PPPoE server 210 that is assigned with the same session ID.
At 342 in FIG. 3 (related to 140 in FIG. 1), if the determination is affirmative, the second PPPoE client 222 sends a probe response to the PPPoE server 210. The probe response may carry the session ID in the probe request, MAC address of the second PPPoE client 222 and MAC address of the PPPoE server.
If the determination is not affirmative (not shown in FIG. 3), as in the case of the first PPPoE client 220, it is not necessary to send a probe response to the PPPoE server 210.

After broadcasting the probe request, the PPPoE server 210 may set a predetermined time period (e.g. using a timer etc.) to wait for a probe response. For example, the predetermined time period may be set based on the time required by the second PPPoE client to process the probe request; time required to send the probe request and probe response (e.g. round trip time); or time required by the first PPPoE client to retransmit a session request to the PPPoE server, etc.

In practice, the predetermined time period may be longer than the sum of (i) the time required to process the probe request by the PPPoE clients and (ii) time to send the probe request and probe response between the PPPoE server and clients. The time period may also be shorter than a time required for the PPPoE clients 220, 222 to re-transmit a PADR message. The latter takes into account errors in receiving a PPPoE Active Discovery Session-confirmation (PADS) message from the PPPoE server 210. Of course, the predetermined time period may be set according to specific network characteristics and adapted in real time.

If a probe response is not received within the predetermined time period, the PPPoE server 210 assumes that there is no assignment conflict. In this case, the following blocks 350 and 352 relating to session termination are skipped.

Termination

Once detected, any pre-established session assigned with the same session ID may be terminated by either the PPPoE server 210 or second PPPoE client 222. See 350 and 352 in FIG. 3 (related to 150 in FIG. 1) respectively.
At 350, the PPPoE server 210 terminates the session by sending a termination message to the second PPPoE client 222. For example, the termination message may be in the form of a PPPoE Active Discovery Termination (PADT) message, which carries the session ID (i.e. the session ID in the probe response sent by the second PPPoE client 222), a destination address of the second PPPoE client's 222 MAC address and a CODE field with the value of 0xa7.
Alternatively, at 352, the second PPPoE client 222 terminates the session by sending a PADT message to the PPPoE server 210 after responding with the probe response at 342. In this case, the destination address of the PADT message is set to the MAC address of the PPPoE server 210.

After receiving or sending the termination message, the second PPPoE client 222 terminates the session assigned with the session ID. This includes removing all related session information from a local storage, such as the session ID and MAC address of the PPPoE server 210 etc. No further PPP traffic is allowed to be sent by the second PPPoE client 222 using that session. Similarly, after sending or receiving a PADT message, the PPPoE server 210 terminates the session with the second PPPoE client 222.

It will be appreciated that the probe request accelerates the detection of a session failure and termination of the session, and reduces the downtime suffered by the second PPoE client 222 accordingly. If the second PPPoE client 222 continues to require the services of PPPoE server 210, a new session may be established using PADI, PADO and PADR messages similar to 302, 304 and 310 in FIG. 3.

Session Confirmation

Once the session with the second PPPoE client 222 is terminated or if a probe response is not received within a predetermined time period, the PPPoE server 210 assigns the selected session ID to the session with the first PPPoE client 220. See 360 and 362 in FIG. 3 (related to 160 in FIG. 1).
At 360, the PPPoE server 210 updates the state of the session ID from ‘to-be-assigned’ to ‘assigned’. This is to prevent the PPPoE server 210 from assigning a session ID in the ‘assigned’ state to other PPPoE clients.
At 362, the PPPoE server 210 sends a PPPoE Active Discovery Session-confirmation (PADS) message to the second PPPoE client 222. The PADS message carries the session ID reserved for the first PPPoE client and a tag of TAG TYPE Service-Name to indicate the service. The destination address of the PADS message is the MAC address of the first PPPoE client 220 and its CODE field is set to 0x65.

Once the first PPPoE client 220 receives the PADS message, the discovery stage ends and PPP session stage begins. The first PPPoE client 220 can then use the assigned session ID to commence a PPP session with the PPPoE server 210.

Example Network Device 400 (PPPoE Server)

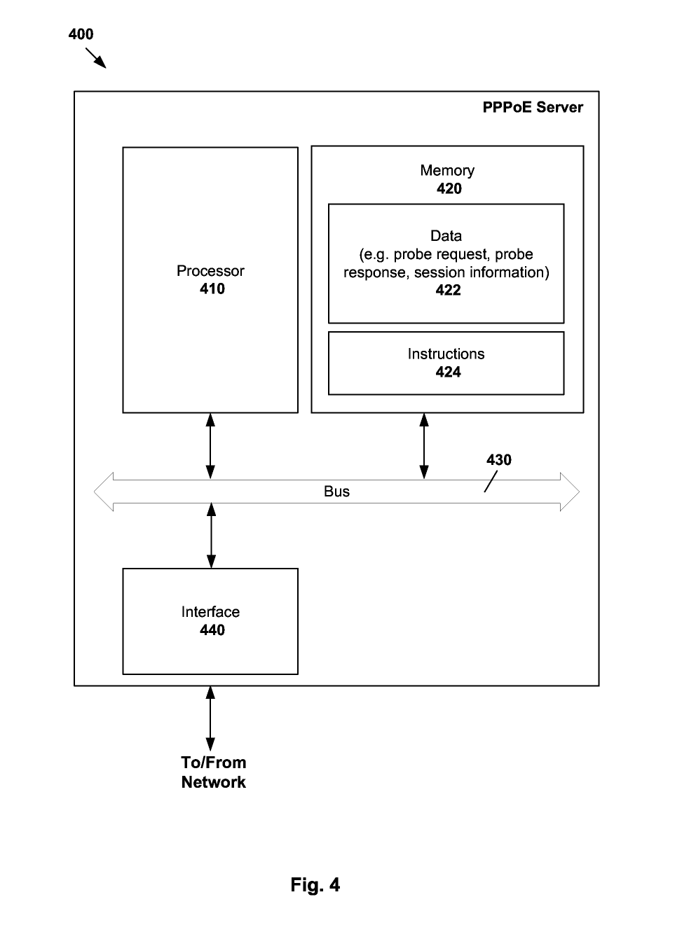

The examples described herein with reference to FIG. 1 to FIG. 3 may be implemented by hardware, software or firmware or a combination thereof. FIG. 4 shows an example network device 400 that is capable of acting as a PPPoE server 210. The example network device 400 includes processor 410, non-volatile memory 420 and interface 440 that communicate with each other via bus 430.

The processor 410 is to perform processes for assigning PPPoE session IDs as described herein with reference to FIG. 1 to FIG. 3. The memory 420 stores machine-readable instructions 424 executable by the processor 410 to cause the processor 410 to perform processes described herein with reference to FIG. 1 to FIG. 3. The network device 400 communicates with PPPoE clients via interface 440. In one example, the processor 410 is to execute the instructions 424 to:
Receive, from a first PPPoE client via interface 440, a session request to establish a new session with the PPPoE server.
Based on the session request, select a session ID for the new session with the first PPPoE client and broadcast a probe request carrying the session ID and a MAC address of the PPPoE server.
When a probe response carrying the session ID is received from a second PPPoE client within a predetermined time period, terminate a prior session with the second PPPoE client, where the probe response indicates that the prior session previously established with the second PPPoE client is assigned with same session ID.
Assign the session ID to the new session with the first PPPoE client.

The memory 420 may store any necessary data 422 for facilitating assignment of PPPoE session IDs, such as information relating to sessions, session IDs, various states of each session ID, probe requests and probe responses. The instructions 424 (not shown in FIG. 4 for simplicity) stored in memory 420 may include:
Instructions to receive, from a first PPPoE client via interface 440, a session request to establish a new session with the PPPoE server.
Instructions to, based on the session request, select a session ID for the new session with the first PPPoE client and broadcast a probe request carrying the session ID and a MAC address of the PPPoE server.
Instructions to terminate a prior session with a second PPPoE client when a probe response carrying the session ID is received from the second PPPoE client within a predetermined time period, where the probe response indicates that the prior session previously established with the second PPPoE client is assigned with same session ID.
Instructions to assign the session ID to the new session with the first PPPoE client.

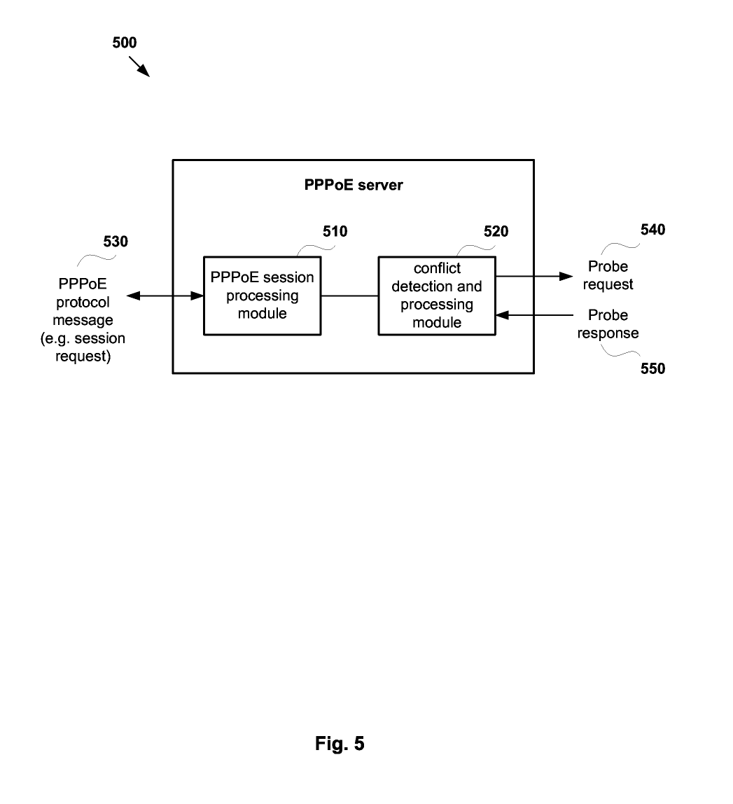

Alternatively or additionally, the example network device 400 may include modules (which may be software, hardware or a combination of both) to perform the processes described with reference to FIG. 1 to FIG. 3. Referring to the example in FIG. 5, the network device capable of acting as a PPPoE server 500 includes a PPPoE session processing module 510 and a conflict detection and processing module 520.
The PPPoE session processing module 510 is to receive a session request from a first PPPoE client to establish a new session with the PPPoE server, select a session ID for the new session with the first PPPoE client, instruct the conflict detection and processing module 520 to broadcast a probe request 530 carrying the session ID and a MAC address of the PPPoE server and assign the session ID to the new session with the first PPPoE client.
The conflict detection and processing module 520 is to broadcast a probe request 530 carrying the session ID and a MAC address of the PPPoE server, terminate a prior session with a second PPPoE client when a probe response 540 carrying the session ID is received from the second PPPoE client within a predetermined time period.

The PPPoE session processing module 510 is further to receive or send and process other PPPoE protocol messages (e.g. PADI, PADO, PADR, PADT, PADS etc.) as described with reference to FIG. 1 to FIG. 3. The conflict detection and processing module 520 is further to perform processes relating to conflict detection, as described with reference to FIG. 1 to FIG. 3.

Example Network Device 600 (PPPoE Client)

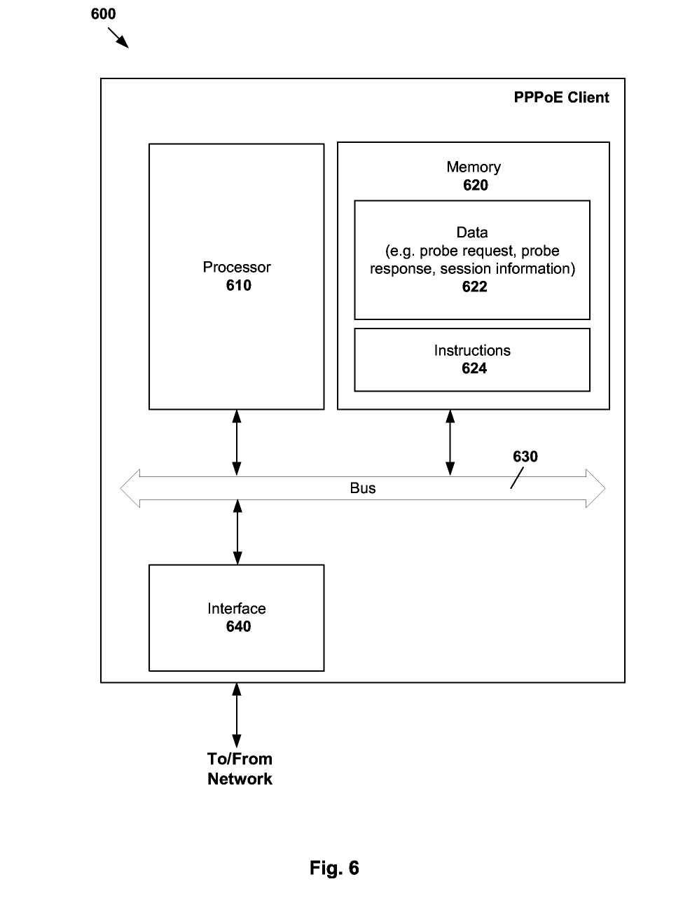

FIG. 6 shows an example network device 600 capable of acting as a PPPoE client 220, 222. The example network device 600 includes processor 610, non-volatile memory 620 and interface 640 that communicate with each other via bus 630. The processor 610 is to perform processes for handling probe requests to avoid or reduce the likelihood of conflicting PPPoE session IDs described herein with reference to FIG. 1 to FIG. 3. Memory 620 may store machine-readable instructions 624 executable by the processor 610 to cause the processor 610 to perform processes described herein with reference to FIG. 1 to FIG. 3. The network device 600 communicates with a PPPoE server via interface 640. In one example, the processor 610 is to execute the instructions to:
Receive, from the PPPoE server via interface 640, a probe request carrying a session ID and a MAC address of the PPPoE server.
Based on the probe request, when a session assigned with the session ID has been previously established with the PPPoE server, send a probe response carrying the session ID to the PPPoE server such that the session is terminated.

The memory 620 may store any necessary data 622 for handling probe requests to avoid or reduce the likelihood of conflicting PPPoE session IDs, such as information relating to sessions, session IDs, probe requests and probe responses. In one example, the instructions 624 (not shown in FIG. 6 for simplicity) stored in memory 620 may include:
Instructions to receive, from a PPPoE server via interface 640, a probe request carrying a session ID and a MAC address of the PPPoE server; and
Instructions to, based on the probe request, when a session assigned with the session ID has been previously established with the PPPoE server, send a probe response carrying the session ID to the PPPoE server such that the session is terminated.

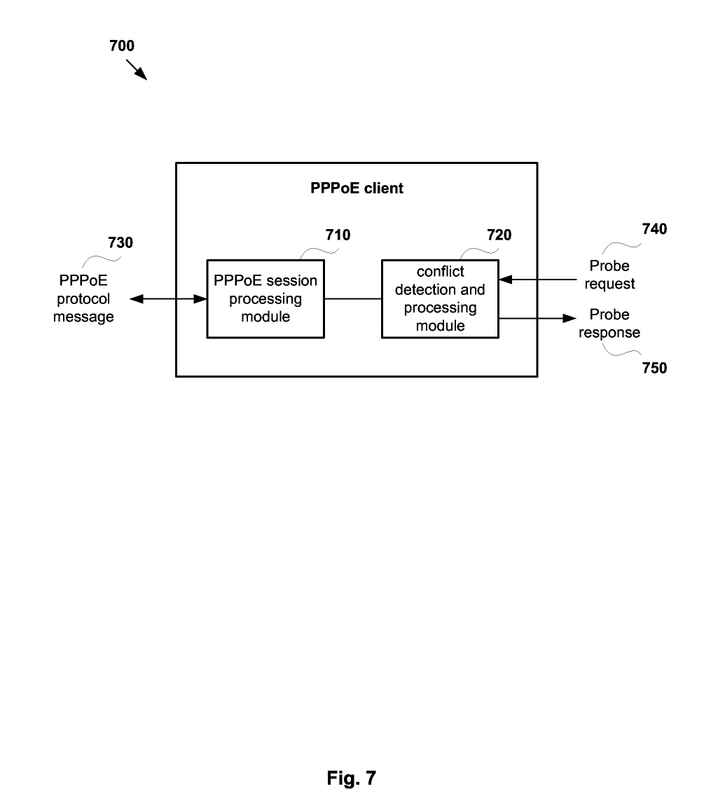

Alternatively or additionally, the example device 600 capable of acting as a PPPoE client 220, 222 may also include modules (which may be software, hardware or a combination of both). Referring to the example in FIG. 7, the network device capable of acting as a PPPoE client 700 includes a PPPoE session processing module 710 and conflict detection and processing module 720.
The PPPoE session processing module 710 is to receive or send PPPoE protocol messages (e.g. PADI, PADO, PADR, PADT, PADS etc.) as described with reference to FIG. 1 to FIG. 3.
The conflict detection and processing module 720 is to receive, from a PPPoE server, a probe request 740 carrying a session ID and a MAC address of the PPPoE server.
The conflict detection and processing module 720 is further to, based on the probe request 740, when a session assigned with the session ID has been previously established with the PPPoE server, send a probe response 750 carrying the session ID to the PPPoE server such that the session is terminated.

The conflict detection and processing module 720 is further to perform processes relating to conflict detection at the PPPoE client 700, as described with reference to FIG. 1 to FIG. 3.

The methods, processes, modules and units described herein may be implemented by hardware (including hardware logic circuitry), software or firmware or a combination thereof. The term ‘processor’ is to be interpreted broadly to include a processing unit, ASIC, logic unit, or programmable gate array etc. The methods, processes, modules and units described herein may all be performed by the one or more processors 410, 610. Reference in this disclosure or the claims to a ‘processor’ should thus be interpreted to mean ‘one or more processors’.

Although one interface 440, 640 is shown, processes performed by the interface 440, 640 may be split among multiple interfaces (not shown for simplicity). As such, reference in this disclosure to an ‘interface’ should be interpreted to mean ‘one or more interfaces’.

Further, the methods, processes, modules and units described in this disclosure may be implemented in the form of a computer software product. The computer software product is stored in a storage medium and comprises a plurality of instructions for making a processor to implement the methods recited in the examples of the present disclosure.

The figures are only illustrations of an example, wherein the modules, units or procedures shown in the figures are not necessarily essential for implementing the present disclosure. Those skilled in the art will understand that the modules or units in the device in the example can be arranged in the device in the examples as described, or can be alternatively located in one or more devices different from that in the examples. The modules or units in the examples described can be combined into one module or unit, or further divided into a plurality of sub-modules or sub-units respectively.

Although the flowcharts described show a specific order of execution, the order of execution may differ from that which is depicted. For example, the order of execution of two or more blocks may be changed relative to the order shown. Also, two or more blocks shown in succession may be executed concurrently or with partial concurrence. All such variations are within the scope of the present disclosure.

Throughout the present disclosure, the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

1. A method for assigning a Point-to-Point over Ethernet (PPPoE) session identifier (ID), comprising a PPPoE server:
receiving a session request from a first PPPoE client to establish a new session with the PPPoE server;
based on the session request, selecting a session ID for the new session with the first PPPoE client and broadcasting a probe request carrying the session ID and a Media Access Control (MAC) address of the PPPoE server;
when a probe response carrying the session ID is received from a second PPPoE client within a predetermined time period, the probe response indicating that a prior session previously established with the second PPPoE client is assigned with same session ID, terminating the prior session with the second PPPoE client; and
assigning the session ID to the new session with the first PPPoE client.

2. The method of claim 1, wherein selecting a session ID for the new session with the first PPPoE client further comprises the PPPoE server:
updating a state of the session ID from idle to to-be-assigned after selecting the session ID.

3. The method of claim 1, wherein assigning the session ID to the new session with the first PPPoE client further comprises the PPPoE server:
updating the state of the session ID from to-be-assigned to assigned.

4. The method of claim 1, wherein terminating the prior session having the session ID with the second PPPoE client comprises the PPPoE server:
sending, to the second PPPoE client, a termination message carrying the session ID to inform the second PPPoE client to terminate the prior session assigned with the session ID; or
receiving, from the second PPPoE client, a termination message carrying the session ID and terminating the prior session with the second PPPoE client.

5. The method of claim 1, wherein the predetermined time period is set based on at least one of the following:
time required by the second PPPoE client to process the probe request;
time required to send the probe request and probe response; and
time required by the first PPPoE client to retransmit a session request to the PPPoE server.

6. A method for assigning a Point-to-Point over Ethernet (PPPoE) session identifier (ID), comprising a PPPoE client:
receiving, from a PPPoE server, a probe request carrying a session ID and a Media Access Control (MAC) address of the PPPoE server; and
based on the probe request, when a session assigned with the session ID has been previously established with the PPPoE server, sending a probe response carrying the session ID to the PPPoE server such that the session is terminated.

7. The method of claim 6, the method further comprising the PPPoE client:
receiving a termination message carrying the session ID from the PPPoE server; and terminating the session having the session ID based on the termination message; or
sending a termination message carrying the session ID to the PPPoE server to inform the PPPoE server to terminate the session having the session ID.

8. A network device for assigning a Point-to-Point over Ethernet (PPPoE) session identifier (ID), wherein the network device is capable of acting as a PPPoE server and comprises an interface to communicate with PPPoE clients, memory storing executable instructions, and a processor to execute the instructions to: receive, from a first PPPoE client, a session request to establish a new session with the PPPoE server;
based on the session request, select a session ID for the new session with the first PPPoE client and broadcast a probe request carrying the session ID and a Media Access Control (MAC) address of the PPPoE server;
when a probe response carrying the session ID is received from a second PPPoE client within a predetermined time period, the probe response indicating that a prior session previously established with the second PPPoE client is assigned with same session ID, terminate the prior session with the second PPPoE client; and
assign the session ID to the new session with the first PPPoE client.

9. The network device of claim 8, wherein when selecting a session ID for the new session with the first PPPoE client, the processor is further to:
update a state of the session ID from idle to to-be-assigned after selecting the session ID.

10. The network device of claim 8, wherein when assigning the session ID to the new session with the first PPPoE client, the processor is further to:
update the state of the session ID from to-be-assigned to assigned.

11. The network device of claim 8, wherein when terminating the prior session having the session ID with the second PPPoE client, the processor is further to:
send a termination message carrying the session ID to the second PPPoE client to inform the second PPPoE client to terminate the prior session assigned with the session ID; or
receive a termination message carrying the session ID from the second PPPoE client and terminate the prior session with the second PPPoE client.

12. The network device of claim 8, wherein the predetermined time period is set based on at least one of the following:
time required by the second PPPoE client to process the probe request;
time required to send the probe request and probe response; and
time required by the first PPPoE client to retransmit a session request to the PPPoE server.

13. A network device for assigning a Point-to-Point over Ethernet (PPPoE) session identifier (ID), wherein the network device is capable of acting as a PPPoE client and comprises an interface to communicate with a PPPoE server, memory storing executable instructions and a processor to execute the instructions to:
receive, from the PPPoE server, a probe request carrying a session ID and a Media Access Control (MAC) address of the PPPoE server; and
based on the probe request, when a session assigned with the session ID has been previously established with the PPPoE server, send a probe response carrying the session ID to the PPPoE server such that the session is terminated.

14. The network device of claim 13, wherein the processor is further to:
receive a termination message carrying the session ID from the PPPoE server; and terminate the session having the session ID based on the termination message; or
send a termination message carrying the session ID to the PPPoE server to inform the PPPoE server to terminate the session having the session ID.
